(19) United States
(12) Patent Application Publication
(10) Pub. No.: US 2014/0340218 A1
(43) Pub. Date: Nov. 20, 2014

(54) Personal Safety Device

(71) Applicants: Michael J. Sutherland, Wylie, TX (US); John W. Darlington, Dallas, TX (US); Russell Logan Spinks, Dallas, TX (US)

(72) Inventors: Michael J. Sutherland, Wylie, TX (US); John W. Darlington, Dallas, TX (US); Russell Logan Spinks, Dallas, TX (US)

(21) Appl. No.: 13/896,354

(22) Filed: May 17, 2013

(51) Int. Cl. G08B 21/02

(52) U.S. Cl. CPC G08B 21/02
USPC 340/539.12

(57) ABSTRACT

A system to provide safety information to a remote location may include a personal safety device to wirelessly transmit a safety signal, a wireless receiver to receive wireless the safety signal from the personal safety device and a wireless device to receive the signals from the wireless receiver.

### FIELD OF THE INVENTION

The present invention relates to a personal safety device and more particularly to a personal safety device which measures temperatures of the user and provides an alarm. The present invention relates to methodology and apparatus for detecting the location of a user and for detecting changes in body temperature of the user and for activating an alarm if the change in body temperature is too great.

This invention is particularly useful in safety and security application, examples of which include users such as older users and younger users who might be unaware of the dangers associated with the change in temperature.

### BACKGROUND

The following patents are incorporated by reference in their entirety.

U.S. Pat. No. 6,353,396 discloses an apparatus and method for the early detection of increased performance impairment, incapacitation or drowsiness of a person, particularly of a person gripping an object such as a steering wheel. A wrist band is worn by the person and an electrical sensor is pressed against the person's skin by the band to sense physiological conditions by detecting various parameters at the wrist and analyzing them to provide an indication of the onset of drowsiness in the person. Some of the parameters analyzed include EMG, temperature, response to stimulation and muscular activity at the wrist. A description of a shock-absorbing wrist monitor is disclosed.

U.S. Pat. No. 7,035,736 discloses a portable personal data processing device, such as a wrist-worn measuring device, a heart rate monitor, a subscriber terminal of a radio system, or a sports watch. The device includes a temperature sensor for measuring the ambient temperature and a humidity sensor for measuring the ambient humidity. Furthermore, dependence information, which defines temperature values of the dew points corresponding to the humidity values, is stored in the device. The control unit is configured to monitor the change rate of the measured temperature, to determine, on the basis of the change rate, the moment at which the temperature reaches the temperature value of the dew point corresponding to the measured humidity on the basis of the dependence information, and to provide a forecast on fog appearance in relation to the moment employing the user interface.

U.S. Pat. No. 6,265,978 discloses an apparatus and method for the early detection of increased performance impairment, incapacitation or drowsiness of a person, particularly of a person gripping an object such as a steering wheel. A wrist band is worn by the person and an electrical sensor is pressed against the person's skin by the band to sense physiological conditions by detecting various parameters at the wrist and analyzing them to provide an indication of the onset of drowsiness in the person. Some of the parameters analyzed include EMG, temperature, response to stimulation and muscular activity at the wrist. A description of a shock-absorbing wrist monitor is disclosed.

U.S. Pat. No. 6,081,194 discloses a signal transmitting and receiving bracelet system for notifying a user wearing a receiving bracelet that a user wearing a transmitting bracelet is in danger. The signal transmitting and receiving bracelet system includes a transmitting bracelet that has sensing and transmitting circuitry having a pressure transducer adapted for contacting a pulse point of a wrist of a user for sensing a pulse of a user. The sensing and transmitting circuitry also has a transmitter that is electrically connected to the pressure transducer to emit a first signal when a user's pulse rate is higher than a predetermined rate. A receiving bracelet has receiving circuitry with a receiver adapted for receiving signals emitted from the transmitting bracelet. The receiving circuitry has a sound emitting device that is electrically connected to the receiver for emitting a sound when a signal is received from the transmitting bracelet.

U.S. Pat. No. 5,917,415 discloses a wrist worn device and method for monitoring and alerting the user of increased drowsiness. The device includes sensors for monitoring several physiological parameters of the user, including peripheral pulse rate variability, peripheral vasomotor response, muscle tone, peripheral blood flow and reaction time variability. If the majority of these parameters are indicative of increased drowsiness, and audio-visual alert is provided the user. The sensors are encased in a shock-absorbing unit and wirelessly transmit the sensed data.

### SUMMARY

A system to provide safety information to a remote location may include a personal safety device to wirelessly transmit a safety signal, a wireless receiver to receive wireless the safety signal from the personal safety device and a wireless device to receive the signals from the wireless receiver.

The wireless device may be a cell phone.

The wireless receiver may be a cell phone carrier.

The personal safety device may include a cell phone transmitter to transmit to a cell phone carrier.

The personal safety device may include an interface receiver to receive transmissions from the wireless device.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a circuit diagram of the present invention;

FIG. 2 illustrates the personal safety device in a wireless network;

FIG. 3 illustrates the personal safety device with an interface receiver;

FIG. 4 illustrates the personal safety device with a global positioning system (GPS);

FIG. 5 illustrates a personal safety device with a temperature sensor bank;

FIG. 6 illustrates a personal safety device on a band.

### DETAILED DESCRIPTION

The present invention includes a personal safety device 101 or apparatus which may be worn by the user for example around the neck or ankle of the user and which may be attached to a band 601 shown in FIG. 6 or the personal safety device may be pinned to clothing of the user. The personal safety device 101 may be worn on a animal or pat either directly or on a collar or on animal clothing.

The present invention may record and or transmit upper or lower exposure temperatures of the user who is using the personal safety device, and the present invention may record and transmit the ambient temperature of the user of the personal safety device, the skin temperature of the user who is using the personal safety device and/or the combination of the ambient temperature and the skin temperature of the user. If the temperature recorded by the personal safety device reaches or exceeds an upper or lower exposure predetermined threshold temperature limit for a predetermined length of time, the personal safety device may activate an audible alarm of the personal safety device, send a message such as a text message to a nearby receiver by blue tooth or other network capabilities and send a alert (audio or text) by cellular service to one or more telephone numbers or any combination of the three.

The personal safety device of the present invention may include a device to include a global positioning system GPS to provide a physical location of the user of the personal safety device at any time, and the movement of the personal safety device may be disabled during rigorous activity in order to prevent the transmission of a false signal.

The personal safety device of the present invention can be reprogrammed by a reprogramming device by the user of the personal safety device, can be reprogrammed remotely by a Bluetooth connection more from a computer or smart phone and can be reprogrammed by a network administrator. The predetermined threshold temperature may be adjusted by the reprogramming device.

The personal safety device may be locked onto the user to prevent the personal safety device from being removed from the user so that it can be only removed by a key.

The personal safety device of the present invention may be inserted into a body piercing (like an ear ring) in order to achieve better temperature measurements and may be inserted completely under the skin of the user so that the personal safety device can only read body temperature.

The personal safety device of the present invention may be incorporated into a watch such as a wrist watch or other type of band.

The personal safety device of the present invention may include an electronic display in order to display information such as the current skin temperature.

The personal safety device of the present invention may be formed with a sports helmet such as a football helmet or other types of clothing in order to monitor the temperature of the helmet or clothing in an effort to prevent hypothermia.

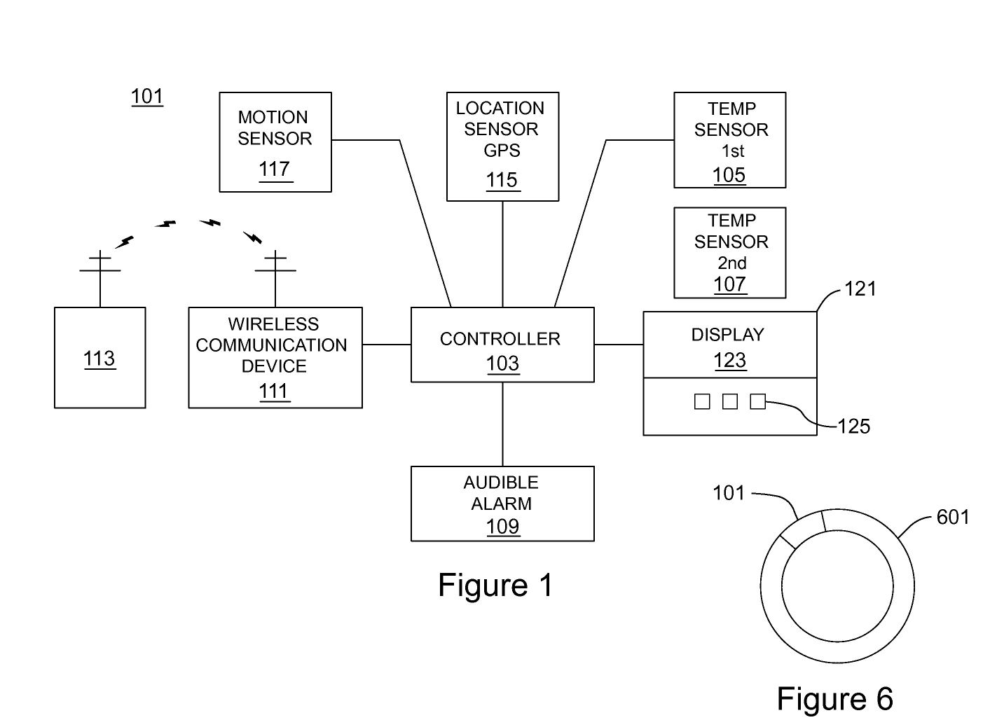

FIG. 1 illustrates a circuit diagram of the personal safety device 101 which may include a controller 103 to control the personal safety device 101. The controller 103 may be connected to a multitude of temperature sensors which may include a first temperature sensor 105 and may be connected to a second temperature sensor 107 which may be placed on different locations on the user of the personal safety device 101 in order to provide a diversity of temperatures.

The controller 103 may be additionally connected to an audible alarm device 109 which may be activated by the controller 103 if the first temperature sensor 105 or the second temperature sensor 107 exceeds a range either plus or minus from a predetermined threshold temperature. Furthermore, the controller 103 may be additionally connected to a wireless communication device 111 (transmitter) which may form a Bluetooth connection or wireless connection from the controller 103 to a wireless receiver and transmitter (a remote device) 113 to receive temperature information including alarm information from the first temperature sensor 105 and or the second temperature sensor 107 and location information obtained from the location sensor 115 which may be a GPS device. The wireless receiver and transmitter 113 may transmit information to the controller 103 in order to change values such as the predetermined threshold temperature. In addition, the controller 103 may receive motion information from the motion sensor 117 in order to deactivate the alarm information from being sent to the remote device 113 when the motion sensor 117 detects motion which exceeds a predetermined motion value which may correspond to vigorous exercise which may naturally raise the temperature of the user.

The controller 103 may be connected to a reprogramming device 121 to allow the user to reprogram the controller 103 by changing the predetermined motion value or the predetermined threshold temperature. The reprogramming device 121 may include a display 123 to display information from the controller 103 and may include a keyboard 125 to input information into the controller 103.

Furthermore, the remote device 113 may include a transmitter to transmit reprogramming information including the predetermined motion value or the predetermined threshold temperature to the wireless communication device 111 which will reprogram the controller 103.

The location sensor 115 may be a GPS device and may provide location information of the user to the controller 103.

The motion sensor 115 may provide motion information of the user to the controller 103. When the motion information exceeds a motion threshold value, the controller 103 may conclude that the user has engaged in heavy activity so that an increase in temperature from the temperature sensors 105, 107 can be safely ignored and will not activate the audible alarm 109.

In operation, the first temperature sensor 105 and the second temperature sensor 107 sense temperature data from the user and transmit the temperature data to the controller 103, and the location sensor 115 determines the location of the user and transmits location information to the controller 103. Additionally, the motion sensor 117 senses the motion of the user and transmits motion information to the controller 103. If the temperature information exceeds the predetermined threshold temperature, and if the motion information is not exceeding a predetermined threshold motion value, the controller 103 activates the wireless communication device 111 to send an alarm to the remote device 113 to allow a second user to be notified of the temperature change of the user. In addition, the controller 103 activates the audible alarm 109 to provide an audible alarm signal. If the motion information exceeds the predetermined threshold motion value, then the controller 103 will not activate the communication device 111 nor the remote device 113.

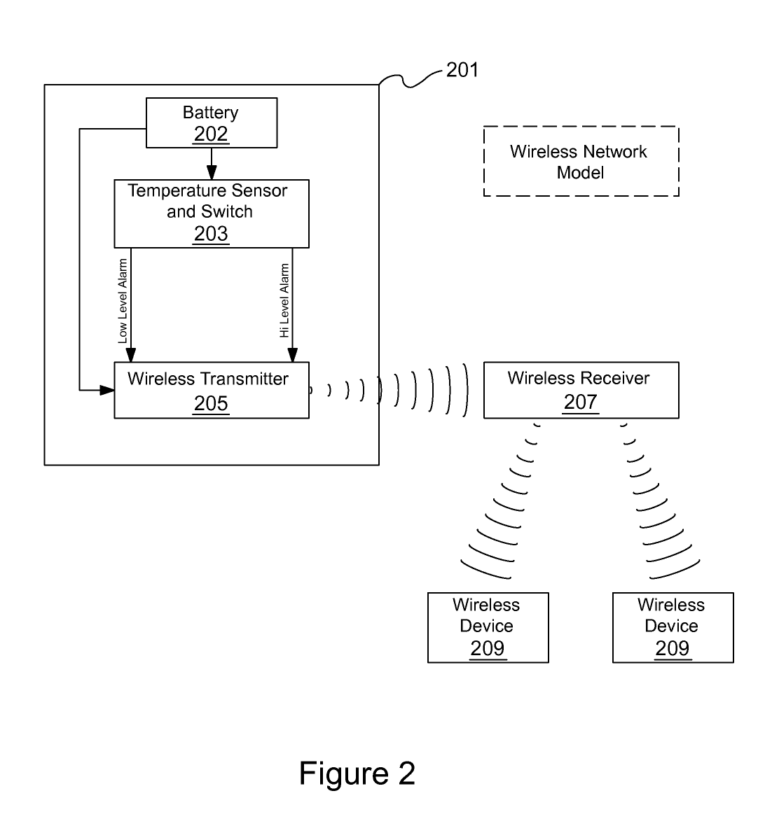

FIG. 2 illustrates another personal safety device 201 which may include a battery 202 to supply power to the temperature sensor and switch 203 and the wireless transmitter 205. The temperature sensor and switch 203 may send a first signal which may be a high level alarm to the wireless transmitter 205 when the temperature of the user exceeds a first predetermined threshold temperature and a second signal which may be a low level alarm to the wireless transmitter 205 when the temperature of the user drops below a second predetermined threshold temperature.

The wireless transmitter 205 receives the first signal and or the second signal from the temperature sensor and switch 203 and transmits the first signal or the second signal to a wireless receiver 207 which may be remote from the personal safety device 201. The wireless receiver 207 may transmit the received signal from the wireless transmitter 205 to a wireless device 209 which may receive the first signal or the second signal which may be communicated to a second user.

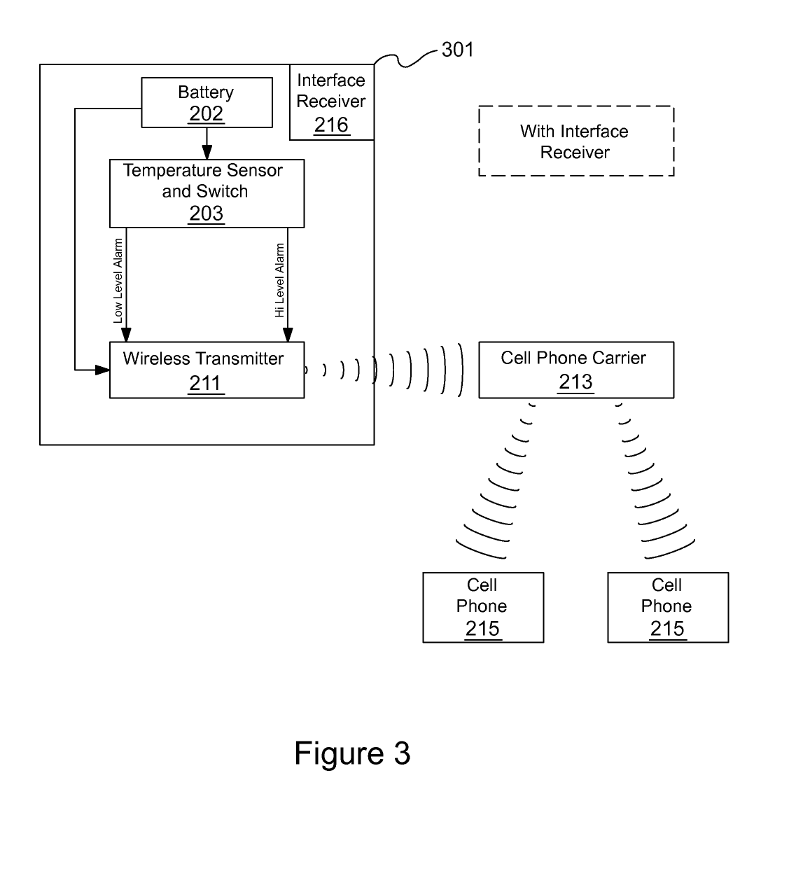

FIG. 3 illustrates another personal safety device 301 which may include a battery 202 to supply power to the temperature sensor and switch 203, the interface receiver 216 and the cell phone transmitter 211. The temperature sensor and switch 203 may send a first signal which may be a high level alarm to the cell phone transmitter 211 when the temperature of the user exceeds a first predetermined threshold temperature and a second signal which may be a low level alarm to the cell phone transmitter 211 when the temperature of the user drops below a second predetermined threshold temperature.

The cell phone transmitter 211 receives the first signal and/or the second signal from the temperature sensor and switch 203 and transmits the first signal or the second signal to a cell phone carrier 213 which may be remote from the personal safety device 301. The cell phone carrier 213 may transmit the received signal from the cell phone transmitter 211 to a cell phone 215 which may receive the first signal or the second signal which may be communicated to a second user.

The second user may transmit a replacement first predetermined threshold temperature and a replacement second predetermined threshold temperature from the cell phone 215 to the cell phone carrier 213, and the cell phone carrier 213 may transmit the replacement first predetermined threshold temperature and the replacement second predetermined threshold temperature to the interface receiver 216 which may be positioned within the personal safety device 301. The interface receiver 216 may transmit the first predetermined threshold temperature and the second replacement predetermined threshold temperature to the temperature sensor and switch 203 to replace the first and second predetermined threshold temperature.

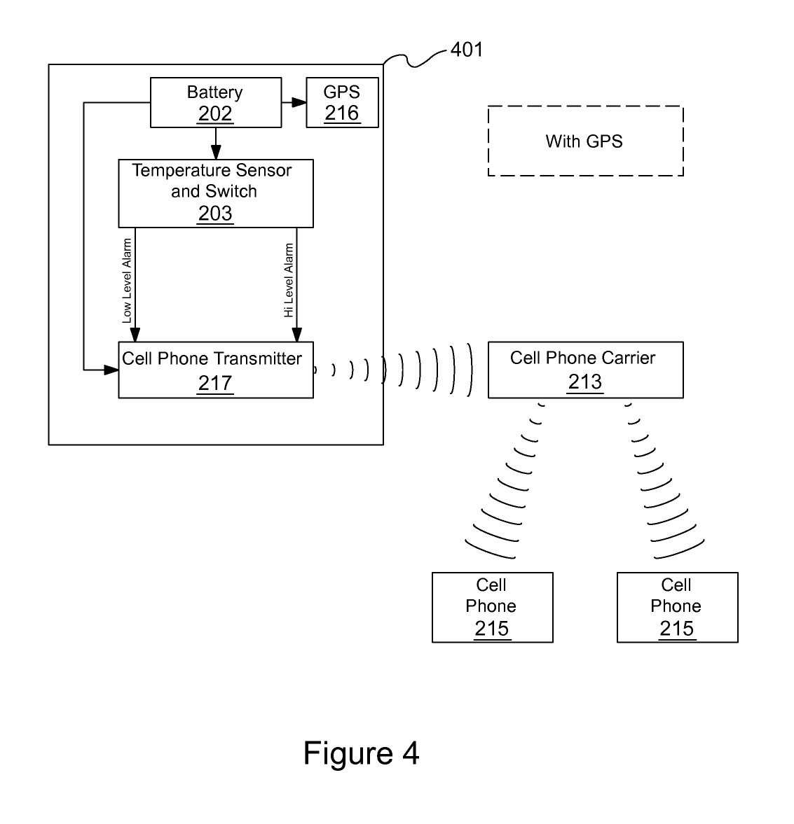

FIG. 4 illustrates another personal safety device 401 which may include a battery 202 to supply power to the temperature sensor and switch 203, the global positioning satellite device (GPS) 216 and the cell phone transmitter 211. The temperature sensor and switch 203 may send a first signal which may be a high level alarm which may include position data of the personal safety device 401 to the cell phone transmitter 211 when the temperature of the user exceeds a first predetermined threshold temperature and a second signal which may be a low level alarm which may include position data of the personal safety device 401 to the cell phone transmitter 211 when the temperature of the user drops below a second predetermined threshold temperature.

The cell phone transmitter 211 receives the first signal and or the second signal from the temperature sensor and switch 203 and transmits the first signal or the second signal to a cell phone carrier 213 which may be remote from the personal safety device 301. The cell phone carrier 213 may transmit the received signal from the cell phone transmitter 211 to a cell phone 215 which may receive the first signal or the second signal which may be communicated to a second user. The second user not only receives the high or low level alarm signal but receives the location data of the user of the personal safety device 401.

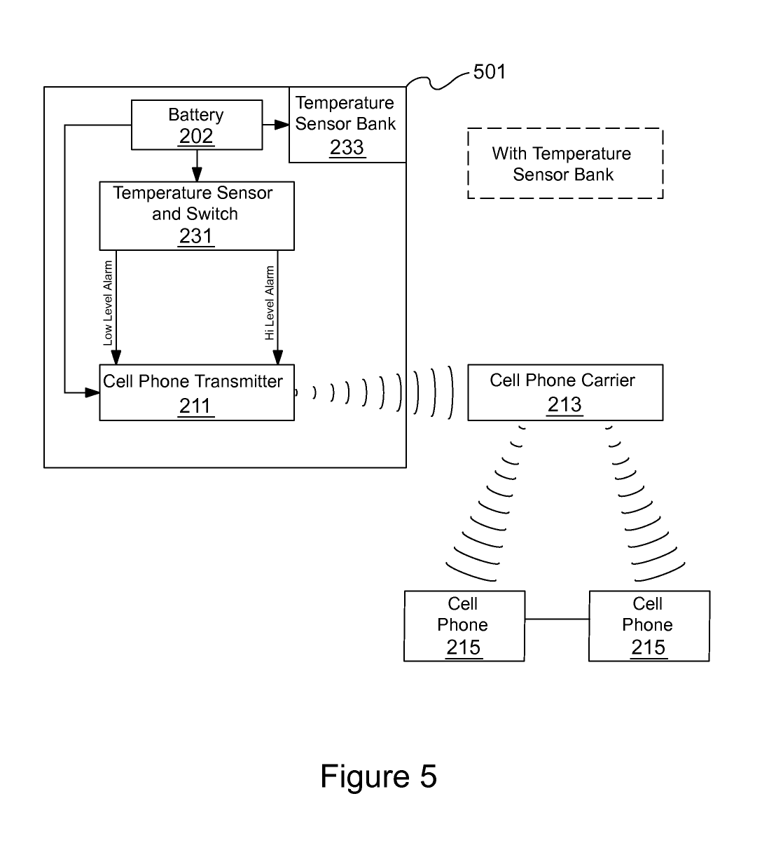

FIG. 5 illustrates another personal safety device 501 which may include a battery 202 to supply power to the switchboard 231, the temperature sensor bank 233 to measure the temperature of the body from a multitude of sensors and the cell phone transmitter 211. The switchboard 231 may send a first signal which may be a high level alarm to the cell phone transmitter 211 when the temperature of the user exceeds a first predetermined threshold temperature and a second signal which may be a low level alarm to the cell phone transmitter 211 when the temperature of the user drops below a second predetermined threshold temperature.

The cell phone transmitter 211 receives the first signal and/or the second signal from the switchboard 231 and transmits the first signal or the second signal to a cell phone carrier 213 which may be remote from the personal safety device 601. The cell phone carrier 213 may transmit the received signal from the cell phone transmitter 211 to a cell phone 215 which may receive the first signal or the second signal which may be communicated to a second user.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A system to provide safety information to a remote location, comprising:
a personal safety device to wirelessly transmit a safety signal;
a wireless receiver to receive wireless the safety signal from the personal safety device;
a wireless device to receive the signals from the wireless receiver.

2) A system to provide safety information to a remote location as in claim 1, wherein the wireless device is a cell phone.

3) A system to provide safety information to a remote location as in claim 1, wherein the wireless receiver is a cell phone carrier.

4) A system to provide safety information to a remote location as in claim 1, wherein the personal safety device includes a cell phone transmitter to transmit to a cell phone carrier.

5) A system to provide safety information to a remote location as in claim 1, wherein the personal safety device includes a interface receiver to receive transmissions from the wireless device.
